(19) United States
(12) Patent Application Publication
(10) Pub. No.: US 2023/0166218 A1
(43) Pub. Date: Jun. 1, 2023

(54) FILTRATION APPARATUS AND FILTRATION SYSTEM INCLUDING THE SAME

(71) Applicant: HIFIL TECH INC., Yongin-si (KR)

(72) Inventors: Hee-Wan MOON, Yongin-si (KR); Yong-Cheol Shin, Yongin-si (KR); Ho-Chan Jung, Yongin-si (KR)

(73) Assignee: HIFIL TECH INC., Yongin-si (KR)

(21) Appl. No.: 18/070,032

(22) Filed: Nov. 28, 2022

(30) Foreign Application Priority Data
Nov. 29, 2021 (KR) 10-2021-0167252

(51) Int. Cl. B01D 63/16; B01D 65/02; B01D 65/08; B01D 63/02; B01D 63/08

(52) U.S. Cl. CPC B01D 63/16; B01D 65/02; B01D 65/08; B01D 63/02; B01D 63/08; B01D 2321/2058; B01D 2313/13; B01D 2313/2031; B01D 2313/21; B01D 2313/54; B01D 2315/06; B01D 2315/04

(57) ABSTRACT

Disclosed are a slidable filtration apparatus capable of performing reciprocating motion in a filtration tank and a filtration system including the same. The filtration apparatus includes a frame and a membrane module installed in the frame, wherein the frame includes at least two horizontal linear motion members provided at an upper portion thereof.

### CROSS REFERENCE TO RELATED APPLICATIONS

This application claims priority based on Korean Patent Application No. 10-2021-0167252 filed Nov. 29, 2021, the content of which is incorporated by reference in its entirety.

### BACKGROUND

### Technical Field

The present disclosure relates to a filtration apparatus and a filtration system including the same, and more particularly to a slidable filtration apparatus capable of performing reciprocating motion in a filtration tank and a filtration system including the same.

### Description of the Related Art

Separation methods for water treatment, i.e., methods for purifying a water by separating contaminants therefrom, include a method using a filtration membrane, a method using heat or phase-change, and so on.

The separation method using a filtration membrane has a lot of advantages over the method using heat or phase-change. Among the advantages is the high reliability of water treatment since the water of desired purity can be easily and stably obtained by adjusting the size of the pores of the filtering membrane. Furthermore, since the separation method using a filtering membrane does not require a heating process, the method can be used together with microorganisms which are useful for separation process but might be adversely affected by heat.

Depending on the shape thereof, the filtration membrane may be classified as a flat sheet membrane or a hollow fiber membrane.

As the water treatment using the filtration membrane is performed, contamination of the filtration membrane with impurities occurs, which significantly decreases the permeability of the filtration membrane. Since various kinds of the impurities cause the contamination of the filtration membrane in different manners, it is also required to clean the filtration membrane with various cleaning methods. For example, cleaning of a contaminated filtration membrane may be classified as continuous cleaning, maintenance cleaning, or recovery cleaning depending on cleaning purpose.

The recovery cleaning, which is a cleaning performed using chemicals for a relatively long time after interruption of the filtration operation, is carried out when the permeability of the filtration membrane is seriously reduced due to the accumulated contamination of the membrane after water treatment operation for a long time. The recovery cleaning substantially restores the permeability of the filtration membrane to the original degree thereof.

On the other hand, the maintenance cleaning is a cleaning performed while water treatment using a filtration membrane is performed or water treatment operation is paused for a moment. The main purpose of the maintenance cleaning is to maintain the permeability of the filtration membrane in a good state. Such maintenance cleaning is performed using a chemical method and a physical method.

On the other hand, the continuous cleaning is mainly performed using an aeration method of ejecting air supplied from a blower to the filtration membrane through aeration holes of an aeration tube while water treatment is performed, thereby removing contaminants from a surface of the membrane. In the aeration method, the contaminants are removed from the surface of the membrane as the rising air bubbles collide with the impurities and cause the turbulence of feed water.

However, the continuous aeration requires huge amount of energy consumption by the blower. Although a cyclic aeration was proposed as a method of reducing energy consumption, there was a limit in reducing the energy consumption amount since a cleaning purpose of preventing deterioration of filtration efficiency due to the filtration membrane contamination must be achieved.

In order to overcome the problem of the aeration cleaning, Korean Patent Application Publication No. 10-2018-0062257A (hereinafter referred to as “Prior Art Document 1”) proposes an apparatus and method capable of preventing or reducing membrane contamination through reciprocating motion of a filtration membrane in a feed water to be treated. Specifically, Prior Art Document 1 discloses that a plurality of membrane support frames, in each of which membrane modules are installed, are connected to a single reciprocating frame together, and the reciprocating frame is reciprocated along a guide rail by a driving unit during the water treatment, whereby a filtration membrane is cleaned.

The method of Prior Art Document 1 has an advantage in that the energy consumption amount is smaller than that of the aeration cleaning method but has problems in that the plurality of membrane support frames must be individually coupled/detached to/from the reciprocating frame, which is troublesome, and a plurality of expensive parts must be used in order to achieve such coupling, which leads to cost increase.

In addition, since the reciprocating frame must have a large size sufficient to be simultaneously connected to the plurality of membrane support frames, (i) a transport restriction imposed by a traffic law requires the parts of the reciprocating frame to be individually transported to a water treatment place and then welded to each other in order to obtain the reciprocating frame, which is inconvenient, (ii) the flatness difference between the reciprocating frame and the guide rail causes noise and increases the possibility of the damage of the parts, and (iii) when other parts, such as the membrane module and the guide rail, are damaged as well as when the reciprocating frame itself is damaged, the entirety of the heavy reciprocating frame must be lifted for repair, which is difficult and inconvenient.

### BRIEF SUMMARY

Therefore, the present disclosure relates to a filtration apparatus that is capable of preventing problems resulting from limitations and shortcomings of the related art described above and a filtration system including the same.

It is an object of the present disclosure to provide a slidable filtration apparatus capable of cleaning a filtration membrane using only relatively small amount of energy less than required in an aeration cleaning mode, improving convenience in manufacture and maintenance, and minimizing any possible damage of the membrane cleaning-related parts.

It is another object of the present disclosure to provide a filtration system capable of cleaning a filtration membrane using only relatively small amount of energy less than required in an aeration cleaning mode, improving convenience in manufacture and maintenance, and minimizing any possible damage of the membrane cleaning-related parts.

In addition to the above objects, other features and advantages of the present disclosure will be described hereinafter, or will be clearly understood by those skilled in the art to which the present disclosure pertains from the following description thereof.

In accordance with an aspect of the present disclosure, the above and other objects can be accomplished by the provision of a filtration apparatus including frame and a membrane module installed in the frame, wherein the frame includes at least two horizontal linear motion members provided at an upper portion thereof.

Each of the horizontal linear motion members may be a roller or a linear bearing.

The frame may include an upper horizontal frame, a lower horizontal frame, and a plurality of vertical members configured to connect the upper horizontal frame and the lower horizontal frame to each other.

The membrane module may include an upper header having a first outlet port provided at one end thereof, a lower header having a second outlet port provided at one end thereof, and a filtration membrane configured to fluidly communicate with the upper header and the lower header, and the upper horizontal frame may include an upper cross pipe configured to allow the one end of the upper header to be coupled thereto via the first outlet port, an upper cross bar configured to allow the other end of the upper header to be coupled thereto, a first upper horizontal member configured to connect one end of the upper cross pipe and one end of the upper cross bar to each other, and a second upper horizontal member configured to connect the other end of the upper cross pipe and the other end of the upper cross bar to each other.

The frame may further include at least two support members respectively coupled to the upper horizontal frame, and the horizontal linear motion members may be installed respectively at the support members.

The support members may be coupled to the first and second upper horizontal members, respectively.

The support members may be undetachably coupled to the upper horizontal frame.

The frame may include a main subframe configured to allow the membrane module to be installed therein, an upwardly-extending subframe provided on the main subframe, and at least two support members respectively coupled to the upwardly-extending subframe, and the horizontal linear motion members may be installed respectively at the support members.

The frame may further include a vertical motion-inhibiting member provided at the upper portion thereof.

The vertical motion-inhibiting member may have a C-channel shape.

The filtration apparatus may further include a plurality of aeration tubes installed at a lower portion of the frame so as to be disposed under the membrane module.

In accordance with another aspect of the present disclosure, there is provided a filtration system including a filtration tank configured to allow feed water to be treated to be introduced thereinto, at least one filtration apparatus described above, the filtration apparatus being configured to perform filtration work while at least a part thereof is submerged in the feed water, a driving unit configured to enable reciprocating motion of the filtration apparatus, a rail configured to guide the reciprocating motion of the filtration apparatus, wherein the filtration apparatus is directly supported and guided by the rail through the horizontal linear motion members.

The driving unit may include a motor, a power transfer member connected to the filtration apparatus, and a motion conversion mechanism configured to convert rotary motion of the motor into linear reciprocating motion of the power transfer member.

The motion conversion mechanism may include a crank configured to be rotated by the motor and a connecting rod having one end connected to the crank and the other end connected to the power transfer member.

The frame may include an upper horizontal frame, a lower horizontal frame, a plurality of vertical members configured to connect the upper horizontal frame and the lower horizontal frame to each other, and at least two support members respectively coupled to the upper horizontal frame, the horizontal linear motion members may be installed respectively at the support members, the motor may be disposed outside the filtration tank, and the power transfer member, the motion conversion mechanism, and the rail may be disposed in the filtration tank.

The driving unit may further include a power transfer mechanism configured to transfer the rotary motion of the motor to the motion conversion mechanism, and only a part of the power transfer mechanism may be disposed outside the filtration tank.

The power transfer mechanism may include a first gear connected to the motor, a second gear, a timing belt configured to transfer rotary motion of the first gear to the second gear, and a shaft configured to transfer rotary motion of the second gear to the motion conversion mechanism.

Alternatively, the power transfer mechanism may include a first gear connected to the motor and a timing belt configured to transfer rotary motion of the first gear to the motion conversion mechanism.

Alternatively, the power transfer mechanism may include a first gear connected to the motor, a second gear engaged with the first gear, and a shaft configured to transfer rotary motion of the second gear to the motion conversion mechanism.

The frame may further include a main subframe configured to allow the membrane module to be installed therein, an upwardly-extending subframe provided on the main subframe, and at least two support members respectively coupled to the upwardly-extending subframe, the horizontal linear motion members may be installed respectively at the support members, and the driving unit and the rail may be disposed outside the filtration tank.

The filtration system may include two or more filtration apparatuses described above, the filtration apparatuses may include a first filtration apparatus connected to the driving unit and a second filtration apparatus, and the first filtration apparatus may be disposed between the driving unit and the second filtration apparatus such that the second filtration apparatus can be linearly moved by linear motion of the first filtration apparatus.

The driving unit may include a motor, a power transfer member connected to the first filtration apparatus by means of at least one first connector, and a motion conversion mechanism configured to convert rotary motion of the motor into linear reciprocating motion of the power transfer member.

The second filtration apparatus may be connected to the first filtration apparatus by means of at least one second connector.

The frame of each of the first and second filtration apparatuses may further include a vertical motion-inhibiting member, and the filtration system may further include a common coupling member commonly coupled to the vertical motion-inhibiting members of the first and second filtration apparatuses.

Each of the vertical motion-inhibiting members of the first and second filtration apparatuses may have a C-channel shape, and the common coupling member may be commonly inserted into recesses of the vertical motion-inhibiting members.

Alternatively, the common coupling member may have a C-channel shape, and the vertical motion-inhibiting members of the first and second filtration apparatuses may be inserted into a recess of the common coupling member together.

The general description of the present disclosure given above is provided merely to illustrate or describe the present disclosure, and does not limit the scope of rights of the present disclosure.

### BRIEF DESCRIPTION OF THE SEVERAL VIEWS OF THE DRAWINGS

The accompanying drawings, which are included to assist in understanding of the present disclosure and are incorporated in and constitute a part of the present specification, illustrate embodiments of the present disclosure and serve to explain the principle of the present disclosure together with the detailed description of the present disclosure.

FIG. 1 is a view schematically showing a filtration apparatus according to an embodiment of the present disclosure;

FIG. 2 is a view schematically showing a frame of a filtration apparatus according to another embodiment of the present disclosure;

FIG. 3 is a view schematically showing a frame of a filtration apparatus according to another embodiment of the present disclosure;

FIGS. 4 to 6 are schematic views describing a filtration system according to an embodiment of the present disclosure;

FIGS. 7A and 7B are views illustrating first and second connectors according to other embodiments of the present disclosure;

FIG. 8 is a view schematically showing a filtration apparatus and a filtration system according to another embodiment of the present disclosure;

FIG. 9 is a view schematically showing a filtration apparatus and a filtration system according to another embodiment of the present disclosure;

FIG. 10 is a view schematically showing a filtration apparatus according to a further embodiment of the present disclosure; and

FIG. 11 is a view schematically showing a filtration system to which the filtration apparatus of FIG. 10 is applied.

### DETAILED DESCRIPTION OF THE DISCLOSURE

Hereinafter, various embodiments of the present disclosure will be described in detail with reference to the accompanying drawings.

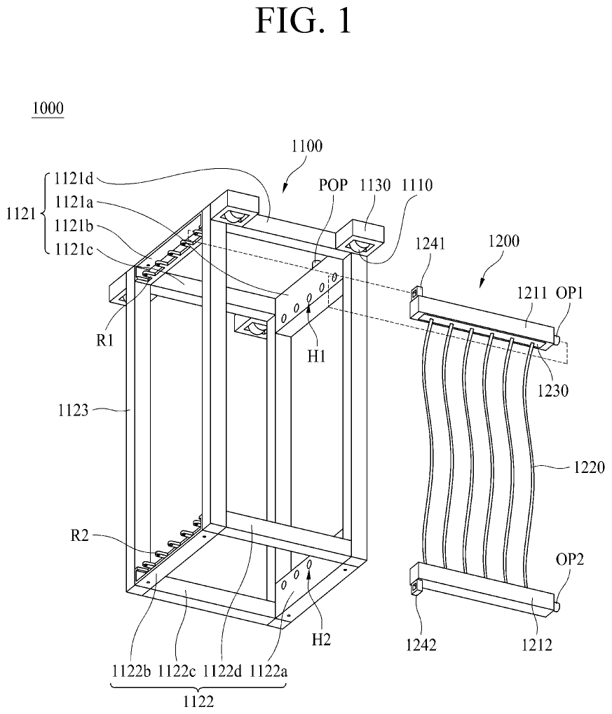

FIG. 1 is an exploded perspective view of a filtration apparatus according to an embodiment of the present disclosure. As illustrated in FIG. 1, the filtration apparatus 1000 according to the present disclosure includes a frame 1100 and a membrane module 1200 installed in the frame.

The frame 1100 includes at least two horizontal linear motion members 1110 provided at an upper portion thereof, whereby the filtration apparatus 1000 according to the present disclosure is capable of reciprocating along a rail (not shown). The horizontal linear motion members 1110 may have any shape/structure as long as the horizontal linear motion members enable the frame 1100 to slide on the rail. As a non-limiting example, each of the horizontal linear motion members 1110 may be a roller (e.g. a cylindrical roller or a guide roller) or a linear bearing.

As the filtration apparatus 1000 according to the present disclosure reciprocates, the membrane module 1200 also reciprocates in feed water contained in a filtration tank (not shown). As a result, only energy less than required in aeration cleaning is used, whereby it is possible to prevent or reduce membrane contamination.

In addition, according to the present disclosure, the filtration apparatus 1000 itself is slidable along the rail, and therefore it is possible to embody reciprocation cleaning without a separate slidable medium, such as the reciprocating frame of Prior Art Document 1. As a result, according to the present disclosure, it is possible to improve convenience in manufacture and maintenance of a filtration system and to minimize damage to membrane cleaning-related parts.

As illustrated in FIG. 1, according to an embodiment of the present disclosure, the frame 1100 may include an upper horizontal frame 1121, a lower horizontal frame 1122, and a plurality of vertical members 1123 configured to connect the upper horizontal frame and the lower horizontal frame to each other.

A membrane module 1200 according to an embodiment of the present disclosure includes an upper header 1211, a lower header 1212, and a filtration membrane 1220 provided therebetween. One end and the other end of the filtration membrane 1220 are fixed respectively to the upper header 1211 and the lower header 1212 via potting layers 1230. The filtration membrane 1220 fluidly communicates with the upper header 1211 and the lower header 1212, whereby permeate transmitted through the filtration membrane 1220 is introduced into water-collecting spaces of the upper header 1211 and the lower header 1212. The upper header 1211 has a first outlet port OP1 for permeate discharge provided at one end thereof. Likewise, the lower header 1212 has a second outlet port OP2 for permeate discharge provided at one end thereof.

Although a hollow fiber membrane is illustrated as the filtration membrane 1220 in FIG. 1, the filtration membrane 1220 of the present disclosure is not limited thereto. The filtration membrane 1220 may be a flat sheet membrane.

The upper header 1211 and the lower header 1212 are coupled respectively to the upper horizontal frame 1121 and the lower horizontal frame 1122 of the frame 1100, whereby the membrane module 1200 is installed in the frame 1100.

The upper horizontal frame 1121 includes an upper cross pipe 1121a, an upper cross bar 1121b, a first upper horizontal member 1121c, and a second upper horizontal member 1121d. The first upper horizontal member 1121c connects one end of the upper cross pipe 1121a and one end of the upper cross bar 1121b to each other, and the second upper horizontal member 1121d connects the other end of the upper cross pipe 1121a and the other end of the upper cross bar 1121b to each other.

Similarly, the lower horizontal frame 1122 includes a lower cross pipe 1122a, a lower cross bar 1122b, a first lower horizontal member 1122c, and a second lower horizontal member 1122d. The first lower horizontal member 1122c connects one end of the lower cross pipe 1122a and one end of the lower cross bar 1122b to each other, and the second lower horizontal member 1122d connects the other end of the lower cross pipe 1122a and the other end of the lower cross bar 1122b to each other.

The first outlet port OP1 of the upper header 1211 is inserted into a first hole H1 of the upper cross pipe 1121a, whereby one end of the upper header 1211 is coupled to the upper cross pipe 1121a. Permeate discharged from the upper header 1211 through the first outlet port OP1 is introduced into the upper cross pipe 1121a and flows out to the outside through a permeate outlet port POP.

Similarly, the second outlet port OP2 of the lower header 1212 is inserted into a second hole H2 of the lower cross pipe 1122a, whereby one end of the lower header 1212 is coupled to the lower cross pipe 1122a. Permeate discharged from the lower header 1212 through the second outlet port OP2 is introduced into the lower cross pipe 1122a.

At least one of the vertical members 1123, which connect the upper cross pipe 1121a and the lower cross pipe 1122a to each other, may have a pipe shape that fluidly communicates therewith, whereby permeate introduced into the lower cross pipe 1122a may flow into the upper cross pipe 1121a and may then be discharged to the outside through the permeate outlet port POP.

Alternatively, a separate permeate outlet port may be formed in the lower cross pipe 1122a such that permeate introduced into the lower cross pipe 1122a is discharged to the outside therethrough.

The other end of the upper header 1211 is coupled to the upper cross bar 1121b. For example, as illustrated in FIG. 1, a first rib R1 provided at the upper cross bar 1121b may be inserted into a first receiving member 1241 provided at the other end of the upper header 1211, whereby the other end of the upper header 1211 may be coupled to the upper cross bar 1121b.

Similarly, a second rib R2 provided at the lower cross bar 1122b may be inserted into a second receiving member 1242 provided at the other end of the lower header 1212, whereby the other end of the lower header 1212 may be coupled to the lower cross bar 1122b.

As illustrated in FIG. 1, the frame 1100 of the present disclosure may further include at least two support members 1130 coupled to the upper horizontal frame 1121, and the horizontal linear motion members 1110 may be installed respectively at the support members 1130.

The support members 1130 may be undetachably coupled to the upper horizontal frame 1121. That is, the support members 1130 may be integrally formed with the upper horizontal frame 1121 by welding.

Since the rail, which guides reciprocating motion of the frame 1100, must be disposed such that the rail and a reciprocating motion path of the frame 1100 interfere with each other, the support members 1130 may protrude from the upper horizontal frame 1121 in a direction perpendicular to a direction of the reciprocating motion.

According to an embodiment of the present disclosure, as illustrated in FIG. 1, a plurality of support members 1130 may be coupled to each of the first and second upper horizontal members 1121c and 1121d, and at least one horizontal linear motion member 1110 may be installed at each of the support members 1130.

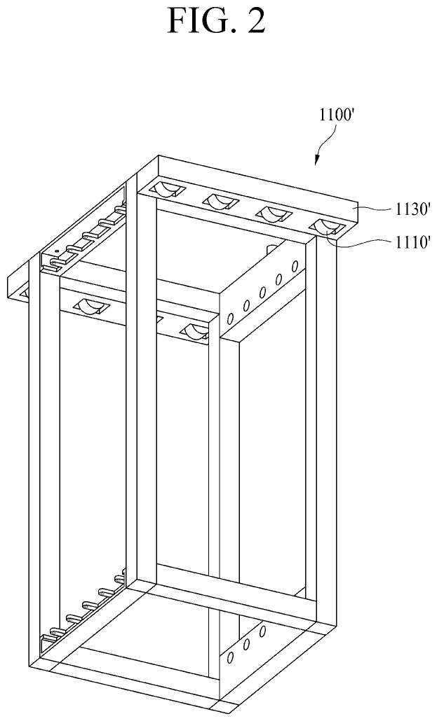

Alternatively, as illustrated in FIG. 2, which schematically shows a frame 1100′ according to another embodiment of the present disclosure, only one relatively long support member 1130′ may be coupled to each of the first and second upper horizontal members, and a plurality of horizontal linear motion members 1110′ may be installed at the support member 1130′.

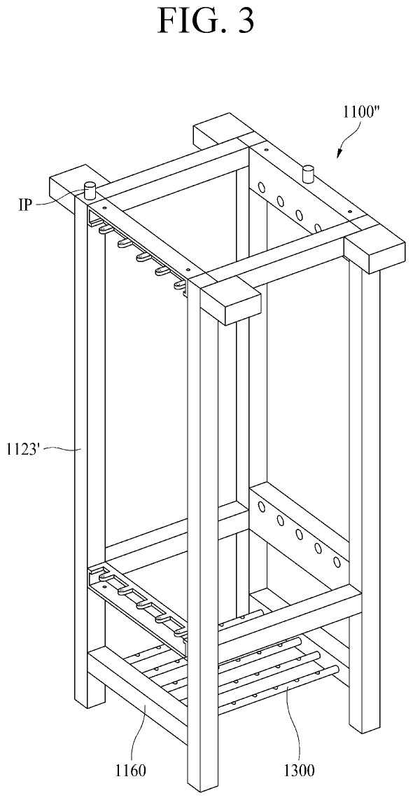

FIG. 3 is a perspective view schematically showing a frame 1100″ according to another embodiment of the present disclosure. As illustrated in FIG. 3, the filtration apparatus according to the present disclosure may further include a plurality of aeration tubes 1300 installed at a lower portion of the frame 1100″ so as to be disposed under the membrane module, whereby it is possible to embody a composite cleaning mode including reciprocation cleaning and aeration cleaning. To this end, vertical members 1123′ of the frame 1100″ extend under the lower horizontal frame, at least one of the vertical members 1123′ has a pipe shape provided with an inlet port IP, through which air for aeration cleaning is injected, and the pipe-shaped vertical member fluidly communicates with the aeration tubes 1300 via a connection tub 1160.

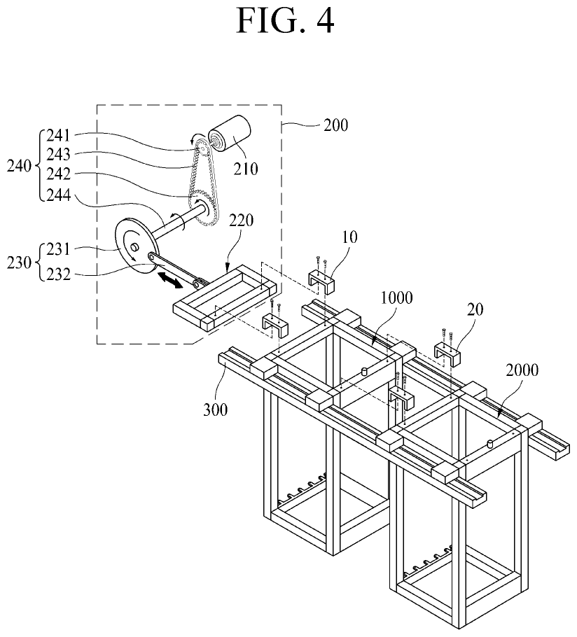

Hereinafter, filtration systems according to various embodiments of the present disclosure will be described in detail with reference to FIGS. 4 to 10. For simplification of the drawings and easy understanding, it should be noted that each of filtration apparatuses 1000 and 2000 is shown as having only a frame without a membrane module.

The filtration system according to the present disclosure includes a filtration tank 100 configured to allow feed water to be treated to be introduced thereinto, at least one filtration apparatus 1000 described above, the filtration apparatus being configured to perform filtration work while at least a part thereof (e.g. a membrane module) is submerged in the feed water, a driving unit 200 configured to enable reciprocating motion of the filtration apparatus 1000, and a rail 300 configured to guide the reciprocating motion of the filtration apparatus 1000.

While the filtration apparatus 1000 performs filtration work, the filtration apparatus 1000 is directly supported and guided by the rail 300 through the horizontal linear motion members 1110.

According to an embodiment of the present disclosure, the driving unit 200 may include a motor 210, a power transfer member 220 connected to the filtration apparatus 1000, and a motion conversion mechanism 230 configured to convert rotary motion of the motor 210 into linear reciprocating motion of the power transfer member 220.

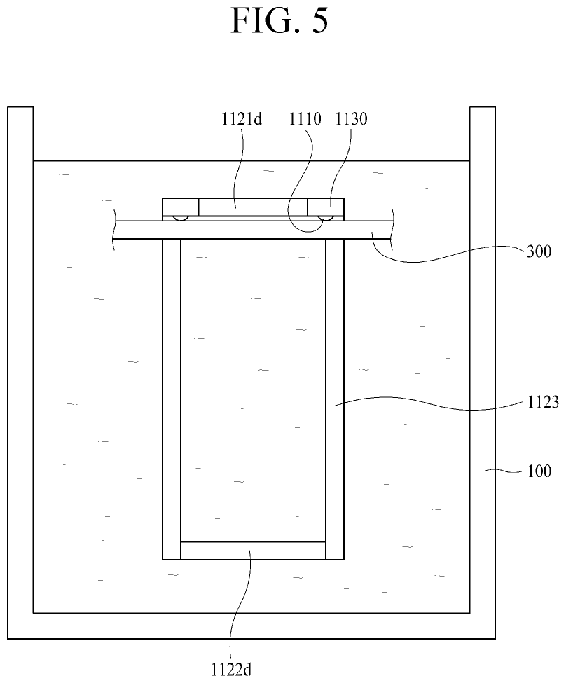

The support members 1130 of the filtration apparatus 1000 according to the embodiment of the present disclosure at which the horizontal linear motion members 1110 are respectively installed, as described above, are coupled to the upper horizontal frame 1121, to which the upper header 1211 of the membrane module 1200 is coupled, (more specifically, the first and second upper horizontal members 1121c and 1121d). In order to perform filtration work, therefore, the entirety of the filtration apparatus 1000 is required to be submerged in the feed water in the filtration tank 100, as illustrated in FIG. 5, which means that the power transfer member 220, the motion conversion mechanism 230, and the rail 300 must also be disposed in the filtration tank 100 (i.e. submerged in the feed water). In contrast, the motor 210, which is an electric part, must be disposed outside the filtration tank 100, since the motor must not be submerged in the feed water.

Consequently, a driving unit 200 according to an embodiment of the present disclosure may further include a power transfer mechanism 240 configured to transfer rotary motion of the motor 210 to the motion conversion mechanism 230. Only a part of the power transfer mechanism 240 is disposed outside the filtration tank 100, and the remaining part thereof is disposed in the filtration tank 100.

As illustrated in FIG. 4, a power transfer mechanism 240 according to an embodiment of the present disclosure may include a first gear 241 connected to the motor 210, a second gear 242, a timing belt 243 configured to transfer rotary motion of the first gear 241 to the second gear 242, and a shaft 244 configured to transfer rotary motion of the second gear 242 to the motion conversion mechanism 230. For example, a part of the timing belt 243 and the first gear 241 may be disposed outside the filtration tank 100, and the remaining part of the timing belt 243, the second gear 242, and the shaft 244 may be disposed in the filtration tank 100. That is, the timing belt 243 transfers rotary motion of the first gear 241 to the second gear 242 in the state in which only a part of the timing belt is submerged in the feed water.

Alternatively, the second gear 242 and the shaft 244 may be omitted, and the first gear 241 and the motion conversion mechanism 230 (more specifically, a crank 231, a description of which will follow) may be connected to each other via the timing belt 243. In this case, the first gear 241 and a part of the timing belt 243 may be disposed outside the filtration tank 100, and the remaining part of the timing belt 243 may be disposed in the filtration tank 100. That is, the timing belt 243 transfers rotary motion of the first gear 241 to the motion conversion mechanism 230 in the state in which only a part of the timing belt is submerged in the feed water.

Alternatively, the first and second gears 241 and 242 illustrated in FIG. 4 may be directly engaged with each other without the timing belt 24. In this case, a part of the second gear 242 and the first gear 241 may be disposed outside the filtration tank 100, and the remaining part of the second gear 242 and the shaft 244 may be disposed in the filtration tank 100. That is, the second gear 242 transfers rotary motion of the first gear 241 to the shaft 244 in the state in which only a part of the second gear is submerged in the feed water.

As illustrated in FIG. 2, the motion conversion mechanism 230 may be a crank-rod mechanism. That is, the motion conversion mechanism 230 may include a crank configured to be rotated by the motor 210 and a connecting rod having one end connected to the crank 231 and the other end connected to the power transfer member 220.

Alternatively, the motion conversion mechanism 230 may be a cam-follower mechanism.

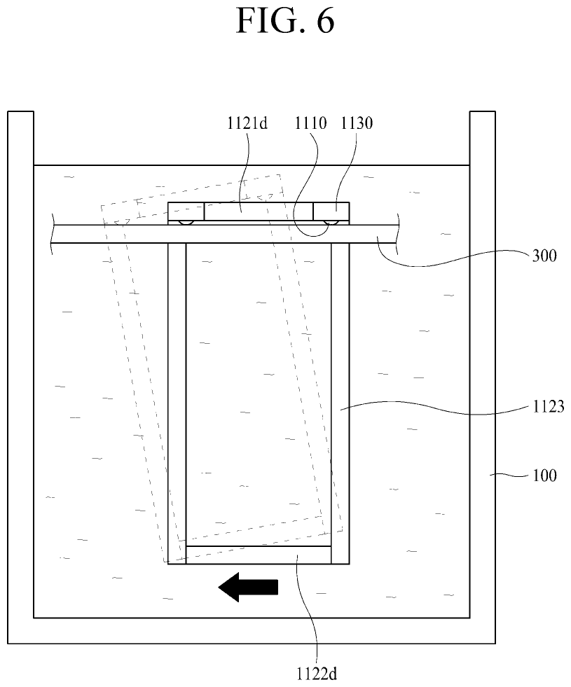

Meanwhile, as illustrated in FIG. 6, when the filtration apparatus 100 reciprocates in a state of being submerged in the feed water in the filtration tank 100 in order to perform filtration work, a rear part of the filtration apparatus 100 that moves (i.e. an opposite part in a movement direction) may be lifted by resistance of the water, whereby the filtration apparatus may be detached from the rail 300.

Consequently, the filtration system according to the embodiment of the present disclosure may preferably include two or more filtration apparatuses arranged side by side in a direction of the reciprocating motion. For example, as illustrated in FIG. 4, the filtration system may further include a second filtration apparatus 2000, in addition to the first filtration apparatus 1000 connected to the driving unit 200, wherein the second filtration apparatus 2000 may be linearly moved by linear motion of the first filtration apparatus 1000 disposed between the driving unit 200 and the second filtration apparatus 2000.

Specifically, the power transfer member 220 of the driving unit 200 and the first filtration apparatus 1000 may be connected to each other via at least one first connector 10, and the first and second filtration apparatuses 1000 and 2000 may be connected to each other via at least one second connector 20.

As a result, when the first and second filtration apparatuses 1000 and 2000 move toward the driving unit 200, lifting of the rear part of the first filtration apparatus 1000 may be inhibited by a front part of the second filtration apparatus 2000. In addition, when the first and second filtration apparatuses 1000 and 2000 move in the opposite direction, lifting of a rear part of the second filtration apparatus 2000 may be inhibited by a front part of the first filtration apparatus 1000.

According to an embodiment of the present invention, the first connector 10 may be detachably coupled to the power transfer member 220 and one end of the upper horizontal frame of the first filtration apparatus 1000, for example, using a bolt, and the second connector 20 may be detachably coupled to the other end of the upper horizontal frame of the first filtration apparatus 1000 and one end of the upper horizontal frame of the second filtration apparatus 2000, for example, using a bolt. As a result, when any one of a plurality of filtration apparatuses is damaged, connectors coupled thereto may be detached, and only the damaged filtration apparatus is removed from the filtration tank 100 for repair or replacement, whereby it is possible to easily maintain the filtration system at low expenses.

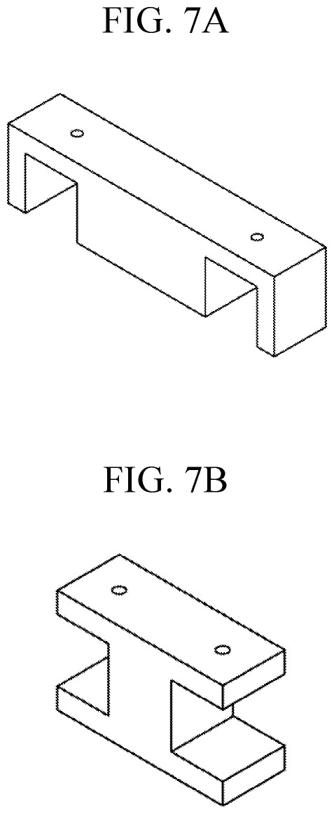

The shape and the structure of each of the first and second connectors 10 and 20 are not particularly restricted as long as it is possible to appropriately perform a power transfer function and a function to inhibit vertical movement of the filtration apparatuses. For example, in order to maintain a predetermined distance between the power transfer member 220 and the first filtration apparatus 100 and/or between the first and second filtration apparatuses 1000 and 2000, each of the first and second connectors 10 and 20 may be a connector having a partition of a thickness corresponding to the predetermined distance between two recesses or a connector having an H-beam shape, as illustrated in FIG. 7A.

Alternatively or additionally, the frame of each of the first and second filtration apparatuses 1000 and 2000 may further include a vertical motion-inhibiting member 1150, and the filtration system may further include a common coupling member 400 commonly coupled to the vertical motion-inhibiting members 1150 of the first and second filtration apparatuses 1000 and 2000.

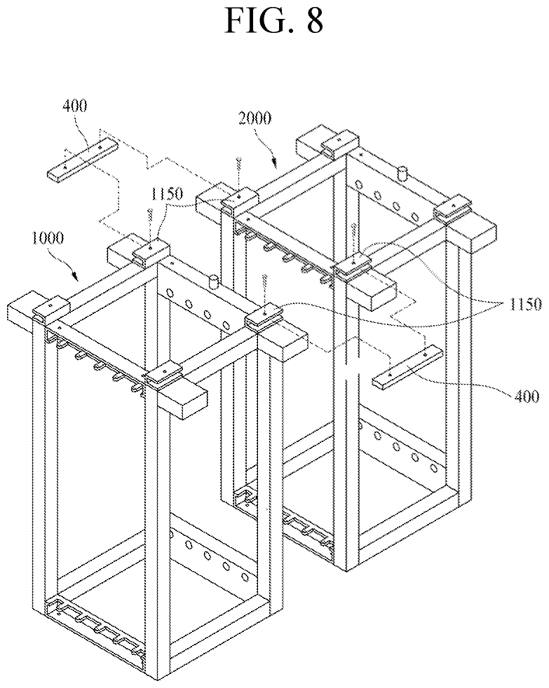

For example, as illustrated in FIG. 8, the vertical motion-inhibiting member 1150 may have a C-channel shape, and the common coupling member 400 may be a fitting strip commonly inserted into recesses of C-channels of the first and second filtration apparatuses 1000 and 2000. The C-channels and the fitting strip may be coupled to each other using a bolt.

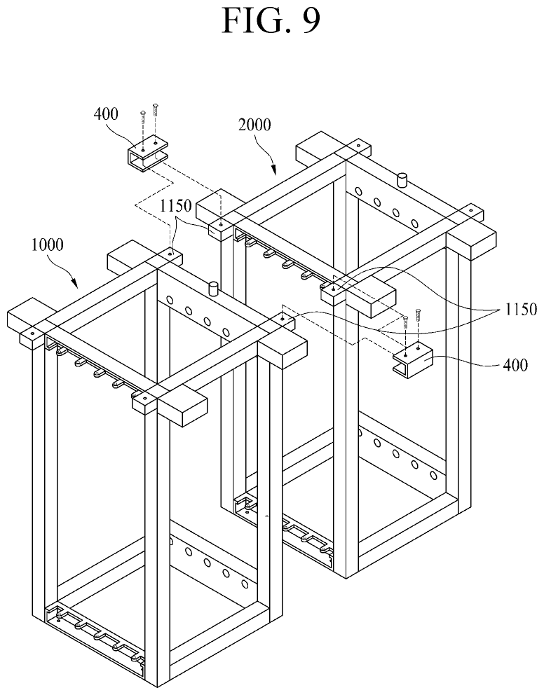

Alternatively, as illustrated in FIG. 9, the vertical motion-inhibiting member 1150 may be a fitting protrusion provided at the frame, and the common coupling member 400 may have a C-channel shape. Consequently, the fitting protrusions of the first and second filtration apparatuses 1000 and 2000 may be inserted into the C-channel-shaped common coupling member 400 together and may then be coupled thereto using a bolt.

Although examples in which the vertical motion-inhibiting member 1150 is disposed at the upper portion of each frame are illustrated in FIGS. 8 and 9, the position of the vertical motion-inhibiting members 1150 of the first and second filtration apparatuses 1000 and 2000 is not particularly restricted as long as the vertical motion-inhibiting members can be commonly coupled to the common coupling member 400.

Combination/coupling between the vertical motion-inhibiting members 1150 of the first and second filtration apparatuses 1000 and 2000 and the common coupling member 400 may transfer reciprocating motion of the first filtration apparatus 1000 to the second filtration apparatus 2000 and may inhibit lifting of the rear part of the first or second filtration apparatus 1000 or 2000 when the first and second filtration apparatuses 1000 and 2000 reciprocate.

The vertical motion-inhibiting members 1150 of the first and second filtration apparatuses 1000 and 2000 may or may not contact each other when being coupled to the common coupling member 400. When the vertical motion-inhibiting members 1150 contact each other, power may be transferred through only the vertical motion-inhibiting members 1150 without intervention of the common coupling member 400 and the bolt when the first filtration apparatus 1000 pushes the second filtration apparatus 2000. In contrast, when the vertical motion-inhibiting members 1150 do not contact each other or when the first filtration apparatus 1000 pulls the second filtration apparatus 2000 even though the vertical motion-inhibiting members contact each other, power may be transferred from the first filtration apparatus 1000 to the second filtration apparatus 2000 through the common coupling member 400 and the bolt.

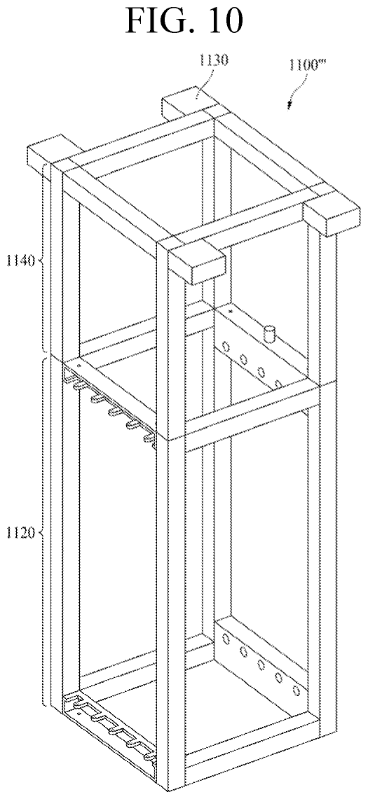

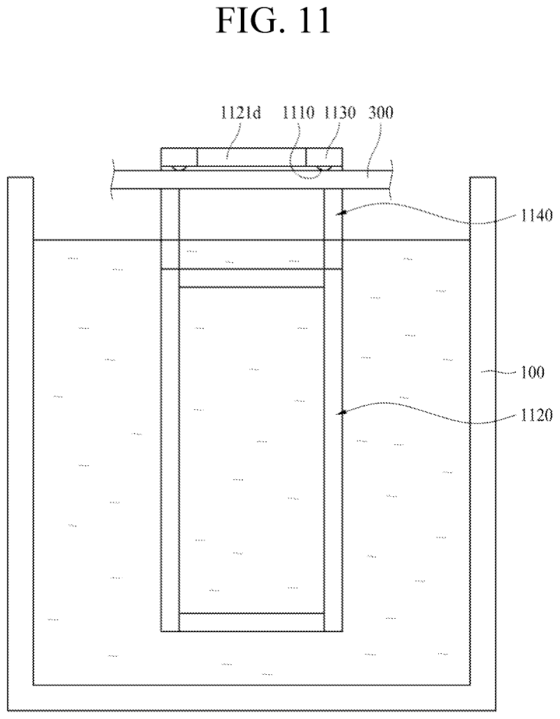

Hereinafter, a filtration apparatus and a filtration system according to a further embodiment of the present disclosure will be described with reference to FIGS. 10 and 11.

When support frames 1130, at which horizontal linear motion members 1110 are respectively installed, are coupled to an upper horizontal frame 1121, to which an upper header 1211 of a membrane module 1200 is coupled, as described above, at least a part of a driving unit 200 and a rail 300 must also be disposed in the filtration tank 100 (i.e. must be submerged in feed water). However, the parts submerged in the feed water to be treated may have low resistance to corrosion, and separate chemical treatment for the parts may be required in order to inhibit corrosion.

In order to solve this problem, as illustrated in FIG. 10, a frame 1100′″ of a filtration apparatus according to a further embodiment of the present disclosure includes a main subframe 1120 configured to allow a membrane module to be installed therein and an upwardly-extending subframe 1140 provided on the main subframe 1120. The main subframe 1120 may be substantially identical to the frames 1100 of the embodiments previously described.

That is, the frame 1100′″ of this embodiment is different from the frames 1100 of the previous embodiments in that the upwardly-extending subframe 1140 is further included at an upper portion thereof and in that at least two support members 1130, at which horizontal linear motion members 1110 are respectively installed, are undetachably coupled to the upwardly-extending subframe 1140, not the main subframe 1120.

According to this embodiment, as illustrated in FIG. 11, the main subframe 1120, in which the membrane module is installed, is submerged in feed water contained in a filtration tank 100, whereas at least a part of the upwardly-extending subframe 1140, the support members 1130, and the horizontal linear motion members 1110 are disposed outside the feed water. In addition, a rail 300 configured to support and guide the filtration apparatus through the horizontal linear motion members 1110 is also disposed outside the filtration tank 100.

In a filtration system to which the filtration apparatus according to this embodiment is applied, the power transfer member 220 of the driving unit 200 is connected to the upwardly-extending subframe 1140 using the first connector 10, whereby the entirety of the driving unit 200 is disposed outside the filtration tank 100.

According to this embodiment, therefore, it is possible to prevent corrosion of the driving unit 200 and the rail 300 due to contact with the feed water without separate chemical treatment.

Of course, combination/coupling between the vertical motion-inhibiting members 1150 and the common coupling member 400 may be additionally or alternatively applied to this embodiment. For example, the vertical motion-inhibiting member 1150 may be installed on the upwardly-extending subframe 1140.

As is apparent from the above description, according to the present disclosure, it is possible to clean a filtration membrane using only energy less than required in an aeration cleaning mode, to improve convenience in manufacture and maintenance of a filtration system, and to minimize damage to membrane cleaning-related parts.

In particular, since only one filtration apparatus is directly connected to a driving unit, and the other filtration apparatuses are sequentially connected to each other in a manner similar to a train such that power can be transferred therebetween, unlike Prior Art Document 1, in which a plurality of filtration apparatuses is commonly connected to a single reciprocating frame, whereby the filtration apparatuses reciprocate according to reciprocating motion of the reciprocating frame, it is possible to fundamentally prevent problems in transport and manufacture caused by adoption of a large-sized reciprocating frame and to selectively maintain a necessary part. In addition, when use of any one filtration apparatus is impossible, connection between the unusable filtration apparatus and the other filtration apparatuses may be released, whereby it is possible to maintain the unusable filtration apparatus in a dormant state.

What is claimed is:

1. A filtration apparatus comprising:
a frame; and
a membrane module installed in the frame, wherein
the frame comprises at least two horizontal linear motion members provided at an upper portion thereof.

2. The filtration apparatus according to claim 1, wherein each of the horizontal linear motion members is a roller or a linear bearing.

3. The filtration apparatus according to claim 1, wherein the frame comprises:
an upper horizontal frame;
a lower horizontal frame; and
a plurality of vertical members configured to connect the upper horizontal frame and the lower horizontal frame to each other.

4. The filtration apparatus according to claim 3, wherein
the membrane module comprises:
an upper header having a first outlet port provided at one end thereof;
a lower header having a second outlet port provided at one end thereof; and
a filtration membrane configured to fluidly communicate with the upper header and the lower header, and
the upper horizontal frame comprises:
an upper cross pipe configured to allow the one end of the upper header to be coupled thereto via the first outlet port;
an upper cross bar configured to allow the other end of the upper header to be coupled thereto;
a first upper horizontal member configured to connect one end of the upper cross pipe and one end of the upper cross bar to each other; and
a second upper horizontal member configured to connect the other end of the upper cross pipe and the other end of the upper cross bar to each other.

5. The filtration apparatus according to claim 4, wherein
the frame further comprises at least two support members respectively coupled to the upper horizontal frame, and
the horizontal linear motion members are installed respectively at the support members.

6. The filtration apparatus according to claim 5, wherein the support members are coupled to the first and second upper horizontal members, respectively.

7. The filtration apparatus according to claim 5, wherein the support members are undetachably coupled to the upper horizontal frame.

8. The filtration apparatus according to claim 1, wherein
the frame comprises:
a main subframe configured to allow the membrane module to be installed therein;
an upwardly-extending subframe provided on the main subframe; and
at least two support members respectively coupled to the upwardly-extending subframe, and
the horizontal linear motion members are installed respectively at the support members.

9. The filtration apparatus according to claim 1, wherein the frame further comprises a vertical motion-inhibiting member provided at the upper portion thereof.

10. The filtration apparatus according to claim 9, wherein the vertical motion-inhibiting member has a C-channel shape.

11. The filtration apparatus according to claim 1, further comprising a plurality of aeration tubes installed at a lower portion of the frame so as to be disposed under the membrane module.

12. A filtration system comprising:
a filtration tank configured to allow feed water to be treated to be introduced thereinto;
at least one filtration apparatus according to claim 1, the filtration apparatus being configured to perform filtration work while at least a part thereof is submerged in the feed water;
a driving unit configured to enable reciprocating motion of the filtration apparatus;
a rail configured to guide the reciprocating motion of the filtration apparatus, wherein
the filtration apparatus is directly supported and guided by the rail through the horizontal linear motion members.

13. The filtration system according to claim 12, wherein the driving unit comprises:
a motor;
a power transfer member connected to the filtration apparatus; and
a motion conversion mechanism configured to convert rotary motion of the motor into linear reciprocating motion of the power transfer member.

14. The filtration system according to claim 13, wherein the motion conversion mechanism comprises:
a crank configured to be rotated by the motor; and
a connecting rod having one end connected to the crank and the other end connected to the power transfer member.

15. The filtration system according to claim 13, wherein
the frame comprises:
an upper horizontal frame;
a lower horizontal frame;
a plurality of vertical members configured to connect the upper horizontal frame and the lower horizontal frame to each other; and
at least two support members respectively coupled to the upper horizontal frame,
the horizontal linear motion members are installed respectively at the support members,
the motor is disposed outside the filtration tank, and
the power transfer member, the motion conversion mechanism, and the rail are disposed in the filtration tank.

16. The filtration system according to claim 15, wherein
the driving unit further comprises a power transfer mechanism configured to transfer the rotary motion of the motor to the motion conversion mechanism, and
only a part of the power transfer mechanism is disposed outside the filtration tank.

17. The filtration system according to claim 12, wherein
the frame further comprises:
a main subframe configured to allow the membrane module to be installed therein;
an upwardly-extending subframe provided on the main subframe; and
at least two support members coupled to the upwardly-extending subframe,
the horizontal linear motion members are installed respectively at the support members, and
the driving unit and the rail are disposed outside the filtration tank.

18. The filtration system according to claim 12, wherein
the filtration system comprises two or more filtration apparatuses according to claim 1,
the filtration apparatuses comprise:
a first filtration apparatus connected to the driving unit; and
a second filtration apparatus, and
the first filtration apparatus is disposed between the driving unit and the second filtration apparatus such that the second filtration apparatus can be linearly moved by linear motion of the first filtration apparatus.

19. The filtration system according to claim 18, wherein
the driving unit comprises:
a motor;
a power transfer member connected to the first filtration apparatus by means of at least one first connector; and
a motion conversion mechanism configured to convert rotary motion of the motor into linear reciprocating motion of the power transfer member, and
the second filtration apparatus is connected to the first filtration apparatus by means of at least one second connector.

20. The filtration system according to claim 18, wherein
the frame of each of the first and second filtration apparatuses further comprises a vertical motion-inhibiting member, and
the filtration system further comprises a common coupling member commonly coupled to the vertical motion-inhibiting members of the first and second filtration apparatuses.
